(19) United States
(12) Patent Application Publication
(10) Pub. No.: US 2009/0276860 A1
(43) Pub. Date: Nov. 5, 2009

(54) METHOD OF PROTECTING CONFIDENTIAL FILE AND CONFIDENTIAL FILE PROTECTING SYSTEM

(76) Inventor: Naohide Miyabashi, Tokyo (JP)

Correspondence Address: MATTINGLY & MALUR, P.C., 1800 DIAGONAL ROAD, SUITE 370, ALEXANDRIA, VA, 22314, US

(21) Appl. No.: 12/088,127

(22) PCT Filed: Jul. 12, 2006
(86) PCT No.: PCT/JP2006/313839

§ 371 Date: Mar. 26, 2008

(51) Int. Cl. G06F 21/24; G06F 21/20; G06F 21/22; G06F 12/00

(52) U.S. Cl. 726/30

(57) ABSTRACT

There is provided a method of protecting confidential files to securely protect business confidential files in accordance with a security policy. In the method of protecting confidential files according to the present invention, information of a business application which is allowed to access confidential files is registered in a management server in advance and the registered application information is distributed to each client as needed. When the business application references confidential files, it is judged (application is authenticated) at the time of starting up the business application whether the business application is the application registered in advance in the server. Only when the application authentication is allowed, process information of the business application is registered in an I/O acquisition module. The I/O acquisition module allows only the process which is consistent with the registered process information to access confidential information, and rejects other processes.

### TECHNICAL FIELD

The present invention relates to a method and a system for protecting business confidential files by controlling access to confidential information by a business application by each application or by each process.

### BACKGROUND ART

Recently, there have been many cases in which important personal information is leaked such as leakage of client information, and protection of client information is an important issue of concern for companies.

In April 2005, the Private Information Protection Law came into full effect by also targeting private businesses, which rapidly increases interest in security management applications.

In the security management applications, it is important to protect business confidential information (data including personal information or the like) which should not be leaked out, or confidential information (operating environment definition information or policy definition information) of the security management applications themselves.

There is disclosed a technique as a method of authenticating an application which is allowed to access confidential files in Patent Document 1 below.

In the technique, a filter module acquires an event issued by API from a business application, and authentication of the application is performed while temporarily suspending issuance of file I/O. File I/O from an allowed business application is allowed and unauthorized file I/O is rejected by an I/O monitoring module.

Patent Document 1: JP Patent Publication (Kokai) No. 2003-108253A

### DISCLOSURE OF THE INVENTION

When confidential information including personal information or the like is dealt with, there are such cases that only a particular business application is allowed and other applications are not allowed to access the confidential information. For example, when it is intended only to reference a confidential file, only a particular viewer is allowed to reference the confidential file and other applications are totally prohibited from accessing the confidential file in order to prevent data of confidential information from being leaked out by storing or printing the data.

It is a serious attack on the security management applications that a confidential file which stores confidential information such as operating environment and policy definition information of the security management application is analyzed and falsified. For example, even when a client sets a policy of prohibiting any operation for removing information to any network or any external medium, confidential information could be freely removed if a malicious third party rewrote the policy definition information.

The technique disclosed in the above Patent Document 1 is suitable for controlling access in the case where a business application references or renews business documents, table files or the like.

However, there are following problems in satisfying the above requirements.

A first problem is that, since the technique is an external authentication method of acquiring an event issued by API, there are generated communication processing between the filter module which acquires the event issued by API and an application authentication module, and communication processing between the application authentication module and the I/O monitoring module, and application performance degrades more significantly than when an authentication method is implemented by an internal code. Even if application authentication is limited to be performed only when file OPEN API is acquired, performance degradation of the application cannot be avoided since file OPEN is often issued.

A second problem is that contents of a hash management table in which information of applications which are allowed to access confidential files is registered are possibly falsified. When a security policy of controlling access to confidential files by each application is applied, a security administrator should unify management of the security policy in a network group and its information should not be falsified at the client.

An object of the present invention is to provide a method and a system for protecting confidential files capable of dynamically performing application authentication in a security management application, preventing performance degradation of the security management application, and securely protecting business confidential files in accordance with a security policy in a group.

In order to achieve the above object, a method of protecting a confidential file according to the present invention is a method of protecting a confidential file to which unauthorized access is prohibited on business grounds, comprising: a first step of registering a business application that is a source of an access request for the confidential file in an application management table held by an application management service operating in a server computer; a second step of, at an application authentication service operating in a client computer, communicating with the application management service of the server computer and caching contents of the application management table in the client computer; a third step of, at an application authentication module implemented in the business application, registering a process of the business application in a process management table of a process authentication and file I/O acquisition module operating in the client computer when the business application is the business application registered in application authentication information cached by the application authentication service; and a fourth step of, at the process authentication and file I/O acquisition module, acquiring an access request for the confidential file, judging whether a process of a source of the access request is the process registered in the process management table, and prohibiting access to the confidential file when the process has not been registered, and allowing access to the confidential file when the process has been already registered.

In the steps 1 and 3, information of an access authority and an accessible period to the confidential file may be registered in the application management table and the process management table, and in the step 4, the access to the confidential file may be limitedly allowed in accordance with the registered access authority and accessible period.

A confidential file protecting system according to the present invention is a confidential file protecting system for protecting a confidential file to which unauthorized access is prohibited on business grounds, comprising: first registering means for registering a business application that is a source of an access request for the confidential file in an application management table held by an application management service operating in a server computer; caching means for, at an application authentication service operating in a client computer, communicating with the application management service of the server computer and caching contents of the application management table in the client computer; second registering means for, at an application authentication module implemented in the business application, registering a process of the business application in a process management table of a process authentication and file I/O acquisition module operating in the client computer when the business application is the business application registered in application authentication information cached by the application authentication service; and access allowing means for, at the process authentication and file I/O acquisition module, acquiring an access request for the confidential file, judging whether a process of a source of the access request is the process registered in the process management table, and prohibiting access to the confidential file when the process has not been registered, and allowing access to the confidential file when the process has been already registered.

The specific configuration of the present invention will be further described in the below best mode for carrying out the invention with reference to the accompanying drawings.

According to the present invention, the application authentication module for performing business application authentication with the application authentication service which authenticates an access right to the confidential file is implemented in the business application. Only when the access right to the confidential file has been already registered by communication between the application authentication module and the application authentication service, the business application is allowed to access the confidential file. Therefore, an unauthorized application in which the application authentication module is not implemented cannot access the confidential file. Accordingly, it is possible to securely protect the confidential file from unauthorized access thereto by the unauthorized application.

Since the application authentication is an authentication method which is independent of the event issued by API, it is possible to implement the authentication method by reducing the frequency of issuing authentication requests and degrading application performance as little as possible. Although process authentication is generated every time file I/O is generated since access control is achieved by filtering the file I/O by each process, an authentication judgment in the process authentication can be achieved only by a simple comparison judgment with a unique identifier such as process ID, and the authentication method can be implemented without causing significant performance degradation.

Since the application authentication service of the client computer is always in operation and communicates with the application management service of the server computer as needed to cache contents of the application management table held by the server computer in a memory, it is not necessary to contact the server computer each time the application is authenticated. Accordingly, performance degradation can be suppressed.

Specifically, when the application authentication information is stored in a memory, there is a much smaller possibility that the application authentication information is falsified by storing the application authentication information in a volatile memory whose memory contents are deleted at the time of power OFF than by storing the application authentication information in a local file. Even when the client computer is stolen, the cached application authentication information is deleted by shutting down the client computer once, and therefore, the application authentication information is in less danger of being abused.

A security administrator registers applications on the server computer and the application authentication information is managed in the server computer and distributed to the client computer. Therefore, the access authority or accessible period of each application can be collectively specified in one network group.

In the present invention, the same security policy can be applied in the network group and a function of unifying management of the policy can be provided.

The present specification incorporates the contents described in the specification and/or the drawings of JP Patent Application No. 2005-319156, on which the priority of the present application is based.

### BRIEF DESCRIPTION OF THE DRAWINGS

FIG. 1 is a functional block diagram for illustrating one embodiment according to the present invention.

FIG. 2 is a table diagram for explaining a schematic configuration of application management information.

FIG. 3 is a table diagram for explaining a schematic configuration of application information.

FIG. 4 is a table diagram for explaining a schematic configuration of process management information.

FIG. 5 is a table diagram for explaining a schematic configuration of process information.

FIG. 6 is a diagram for explaining a schematic configuration of a method of registering an application.

FIG. 7 is a diagram for explaining a schematic configuration of a method of distributing application authentication information.

FIG. 8 is a diagram for explaining access to a confidential file by an authenticated application.

FIG. 9 is a diagram for explaining access to a confidential file by an unauthorized application.

FIG. 10 is a flowchart for schematically illustrating a procedure in which an application issues an authentication request and accesses a confidential file.

FIG. 11 is a flowchart for illustrating a process procedure of application authentication in an application authentication service.

FIG. 12 is a flowchart for illustrating a process procedure in which a process authentication and file I/O acquisition module registers a process.

FIG. 13 is a flowchart for explaining file I/O acquisition of a process authentication and file I/O acquisition module.

FIG. 14 is a diagram for illustrating another embodiment to which the present invention is applied.

FIG. 15 is a table diagram for explaining a schematic configuration of application information of an application 1.

FIG. 16 is a table diagram for explaining a schematic configuration of application information of an application 2.
1 Client computer
7 Memory
8 Server computer
101 Business application
102 Application authentication service
103 Process authentication and file I/O acquisition module
104 Application management service
105 Application authentication module
106 Application authentication information
107 Access management table
109 Confidential file
110 General file
306, 1506, 1606 Accessible period
307, 1507, 1607 Access authority
1508, 1608 Access-allowed file path name

### BEST MODE FOR CARRYING OUT THE INVENTION

One embodiment for carrying out the present invention will be specifically described below with reference to the drawings.

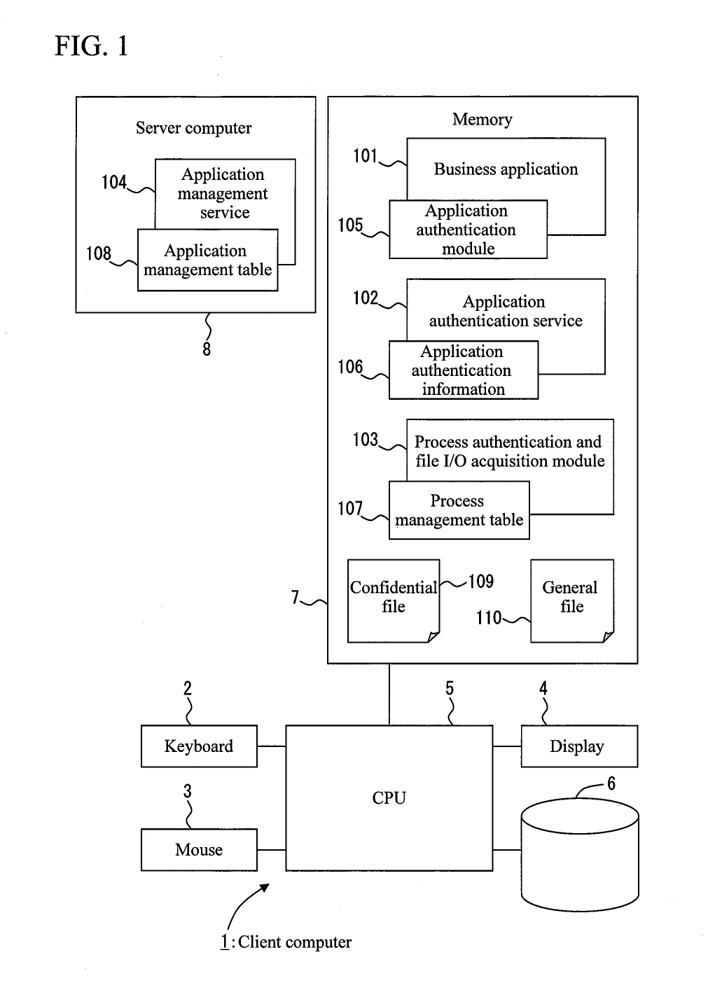

FIG. 1 is a functional block diagram for illustrating one embodiment of a system (confidential file protecting system) to which the present invention is applied.

A client computer (confidential file protecting device) 1 comprises a keyboard 2, a mouse 3, a display 4, a CPU 5, an external memory device 6, and a memory 7 in which a business application 101 for use in various operations is stored.

A process authentication and file I/O acquisition module 103 for protecting a confidential file 109 is also stored therein.

The process authentication and file I/O acquisition module 103 comprises a process management table 107. The process authentication and file I/O acquisition module 103 resisters a process, acquires a file I/O command, and performs process authentication by management information registered in the process management table 107. With respect to a file I/O command from a process which is rejected by the authentication, access to the confidential file 109 is not allowed. Meanwhile, with respect to a file I/O command from an application which is allowed by the authentication, access to the confidential file 109 is limitedly allowed in accordance with an access authority or an accessible period registered in the process management table 107.

An application authentication service 102 stores (caches) application authentication information 106 in the memory. The application authentication information 106 is latest information obtained as needed from an application management table 108 of a server computer 8 via an application management service 104 of the server computer 8, and is information concerning business applications which are allowed to access the confidential file 109 by the server computer 8.

When application authentication is requested from an application authentication module 105 implemented in the business application 101, the application authentication service 102 performs application authentication based on the application authentication information 106. When the authentication is allowed, the application authentication service 102 registers process information of the application which is allowed by the authentication in the process management table 107, and leaves subsequent access control to the process authentication and file I/O acquisition module 103. When the authentication is rejected, the application authentication service 102 performs no operation.

The application management service 104 of the server computer 8 comprises the application management table 108, monitors registration state by an administrator of business applications which are allowed to access the confidential file 109, and distributes application information registered in the application management table 108 to the client computer 1 as needed. When application registration is requested by an administrator, the application information (information shown in FIG. 3) is registered in the application management table 108.

The confidential file 109 is a file which stores confidential information which is prohibited from being disclosed and removed outside, or confidential information such as operating environment definition information or policy definition information of a security management application. A general file 110 is a file other than the confidential file 109. The security management application is an application for prohibiting various data including the general file 110 from being disclosed or removed outside, and in the present invention, the confidential information such as the operating environment definition information or the policy definition information of the security management application is prevented from being illegally falsified or leaked, to protect a security function of the security management application so that the security function is not lowered.

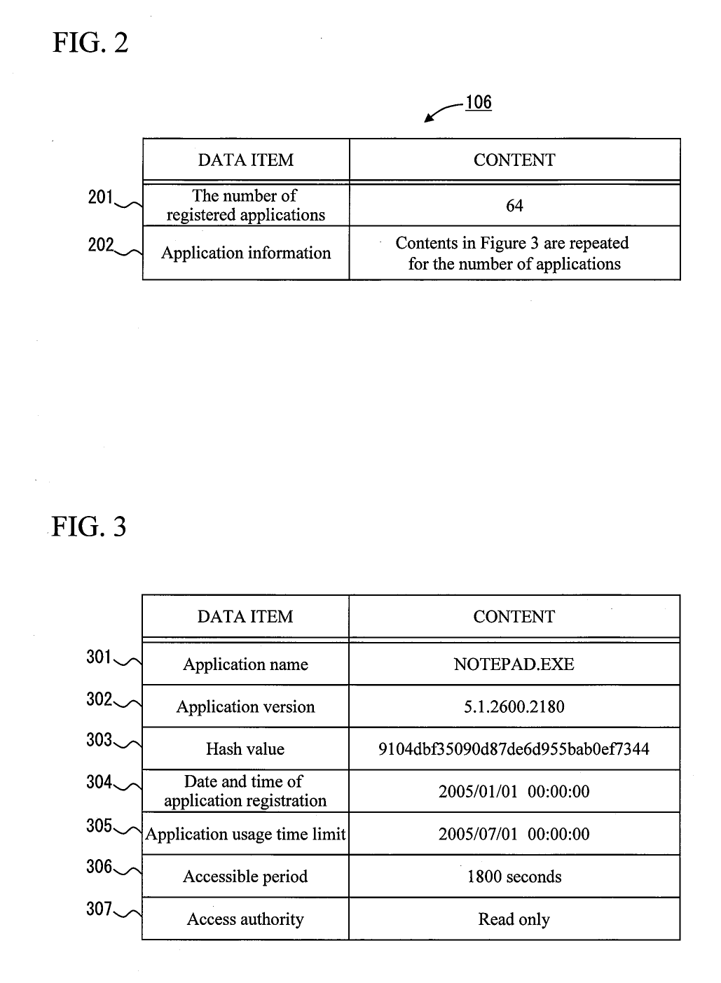

FIG. 2 shows an example of memory contents (application authentication information) of the application management table 108 held by the application management service 104 of the server computer 8. The number of applications (the number of registered applications) 201 which are allowed to access the confidential file 109, and application information 202 constituted by an access authority or the like concerning the applications are registered therein.

The application information 202 is constituted by an application name 301, an application version 302, a hash value 303, date and time of application registration 304, an application usage time limit 305, an accessible period 306, and an access authority 307 of the application which is allowed to access the confidential file 109, as shown in FIG. 3. The hash value is a value calculated using a hash function for generating a pseudo-random number of fixed length from given data, and it is extremely difficult to generate different data having the same hash value.

The hash value 303 is a value generated using the hash function from binary data of an execution program file of the business application 101. When the business application 101 is authenticated, the hash value 303 is used for judging whether the business application 101 is an authorized business application registered in the server computer 8.

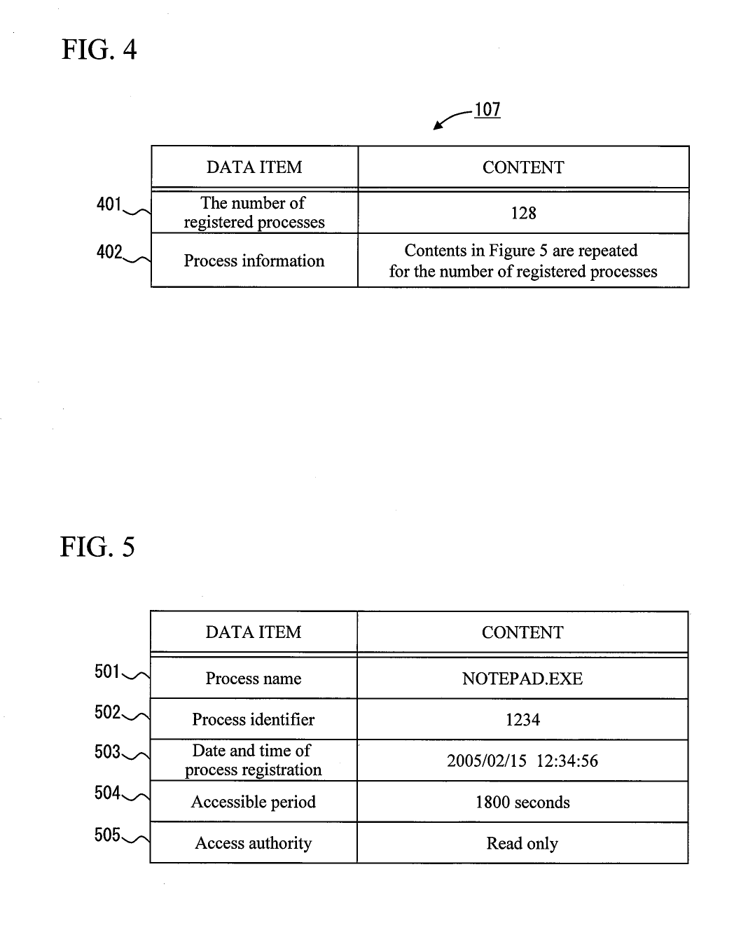

FIG. 4 shows an example of registration and contents of the process management table 107 held by the process authentication and file I/O acquisition module 103. The number of processes (the number of registered processes) 401 which are allowed to access the confidential file 109, and process information 402 constituted by a process identifier or the like concerning the processes are registered therein.

The process information 402 is constituted by a process name 501, a process identifier 502, date and time of process registration 503, an accessible period 504, and an access authority 505 of the process which is allowed to access the confidential file 109, as shown in FIG. 5.

The process identifier 502 is a process unique value such as process ID added by an operating system (OS) of the client computer 1.

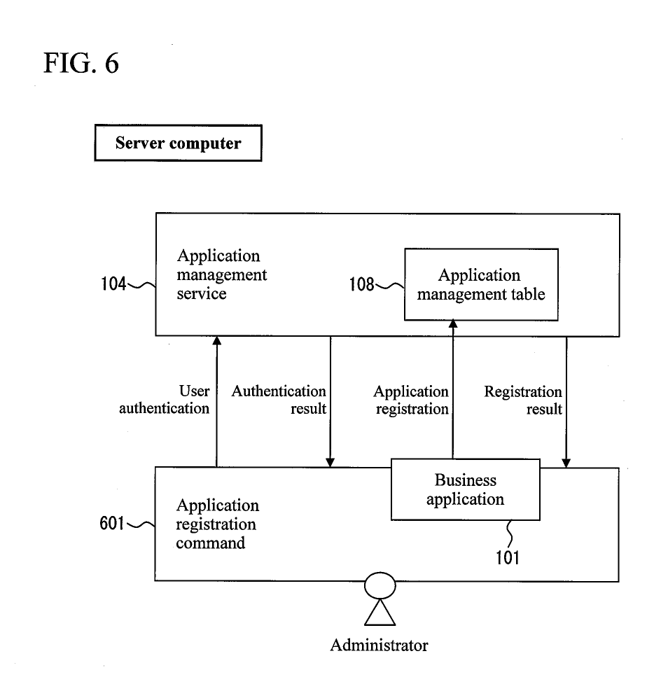

FIG. 6 shows a flow for registering the business application 101 which is allowed to access the confidential file 109 in the application management service 104 operating in the server computer 8.

In FIG. 6, an administrator performs user authentication by a preset user name and password with the application management service 104. When the user authentication is allowed, various information such as the application name, application version, hash value, application usage time limit, access authority or the like of the business application 101 to be registered are stored in the application management table 108 via the application management service 104.

When there are flaws in the application information given to the application management service 104, or when the same application information has been already registered, the application management service 104 returns a registration error result to an application registration command 601. When the registration has been completed without problems, a registration success result is returned.

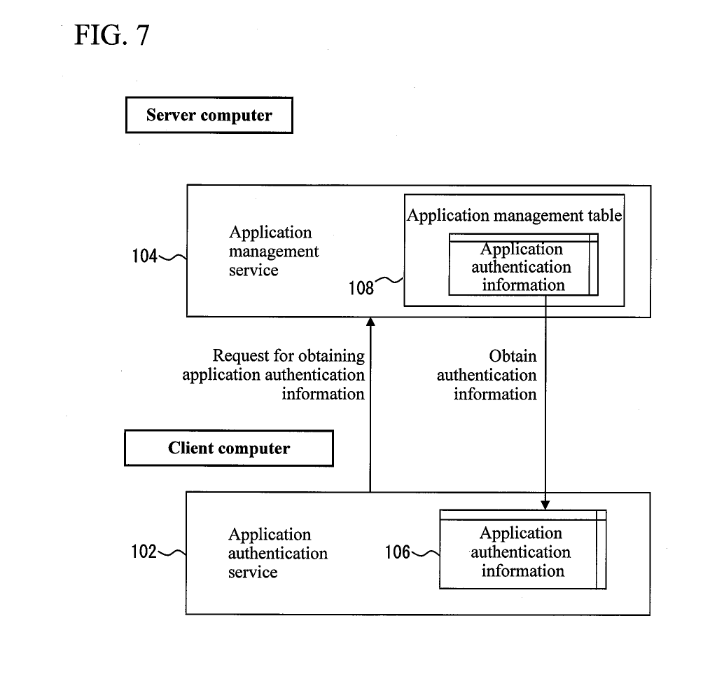

FIG. 7 shows a flow in which the application authentication service 102 operating in the client computer 1 obtains the latest application authentication information 106 held by the server computer 8.

The application authentication service 102 receives the application information from the server computer 8 as needed and caches the latest application authentication information 106. In order to avoid redundant communication with the server computer 8, the latest application information 106 is obtained at the time of starting up the OS or logging into the OS, or is renewed when the latest application authentication information 106 is distributed from the server computer 8.

When obtaining the latest application authentication information 106, the application authentication service 102 issues a request for obtaining the latest application authentication information 106 against the application management service 104, and obtains the application authentication information 106 via the application management service 104.

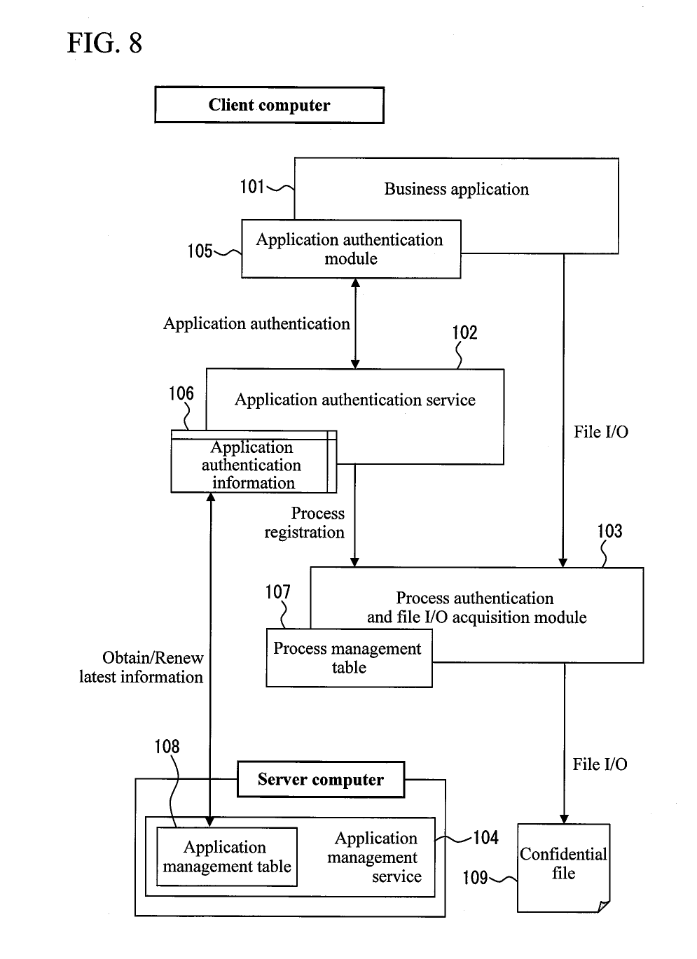

FIG. 8 shows a structure in which the authenticated business application 101 references the confidential file 109.

In the example of FIG. 8, the authenticated business application 101 has been already authenticated in the process authentication and file I/O acquisition module 103 via the application authentication module 105 and the application authentication service 102, and its process information has been already registered in the process management table 107.

When the business application 101 accesses the confidential file 109, a file I/O command for the confidential file 109 is issued.

The process authentication and file I/O acquisition module 103 acquires the file I/O command and searches the process of the request source business application 101 in the process management table 107. Since the process has been already registered, the business application 101 is allowed to access the confidential file 109 in a range of the access authority and for the accessible period in accordance with the process information registered in the process management table 107.

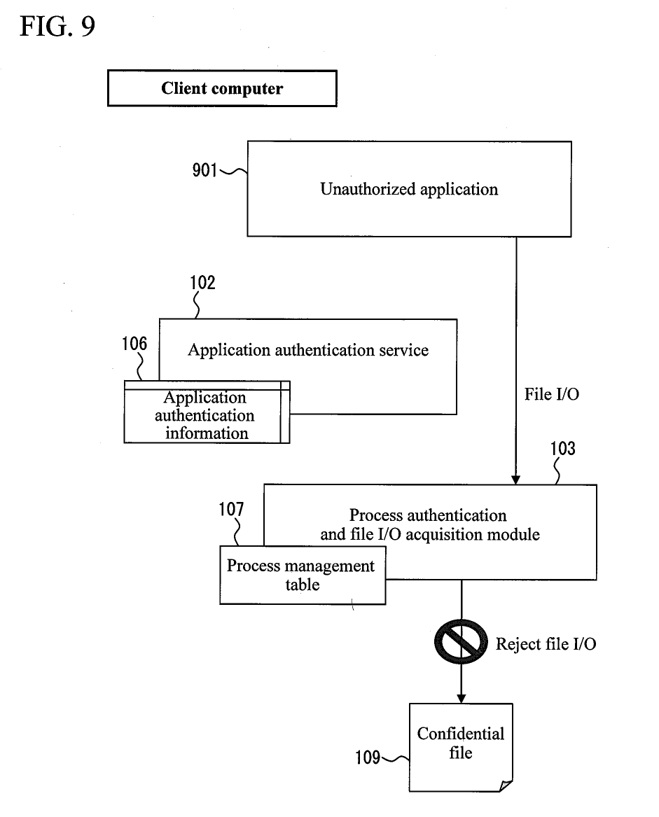

FIG. 9 shows a structure for prohibiting an unauthorized application 901 from accessing the confidential file 109.

Since the unauthorized application 901 does not have the application authentication module 105, application authentication cannot be performed. Thus, process information of the unauthorized application 901 has not been registered in the process management table 107.

When the unauthorized application 901 attempts to access the confidential file 109, a file I/O command for the confidential file 109 is issued. The process authentication and file I/O acquisition module 103 acquires the file I/O command and searches the process of the request source unauthorized application 901 in the process management table 107. Since the process of the unauthorized application 901 has not been registered, the file I/O command is returned to the request source as error.

Accordingly, the unauthorized application 901 is prohibited from accessing the confidential file 109.

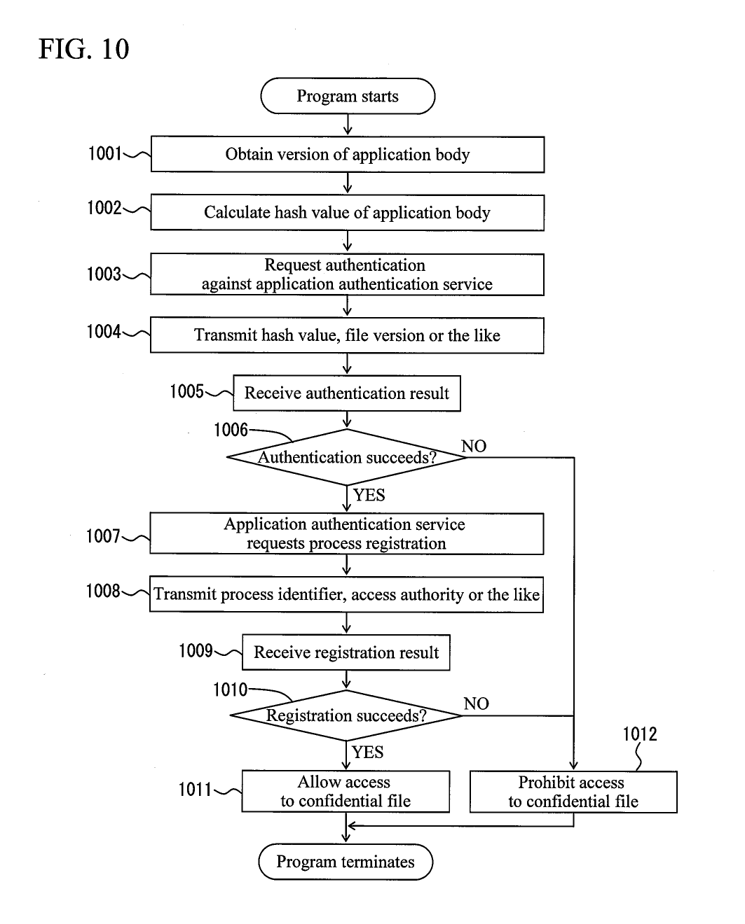

FIG. 10 is a flowchart for schematically illustrating a procedure in which the business application 101 registers its process in the process authentication and file I/O acquisition module 103, and it is judged whether access to the confidential file 109 is to be allowed or rejected.

It is necessary for the business application 101 to register the process information as shown in FIG. 5 such as the process name for use by the application, the accessible period to the confidential file or the like, in the process authentication and file I/O acquisition module 103 before accessing the confidential file 109.

First, the application authentication module 105 of the business application 101 obtains the application name of the business application from an execution file name of the business application, and a version of the business application from a resource of the execution file, which are necessary for authenticating the business application 101 (step 1101). The application authentication module 105 also calculates a hash value (step 1002). Then, the application authentication module 105 issues an application authentication request against the application authentication service 102 (step 1003), and transmits the information of the version, the hash value or the like (step 1004).

By comparing the information received from the application authentication module 105 and the cached application authentication information 106, the application authentication service 102 performs authentication to determine whether the business application 101 is the business application which is allowed to access the confidential file by the server computer 8, and returns the authentication result to the application authentication module 105 (step 1005).

When the authentication fails (when the access to the confidential file has been prohibited), the application authentication module 105 terminates operation with no further operation.

When the authentication succeeds, the application authentication service 102 issues a process registration request against the process authentication and file I/O acquisition module 103 (step 1007), and obtains and transmits the process identifier, the access authority or the like to register the information in the process management table 107. The process identifier of the process during processing execution can be obtained from the OS. The application authentication service 102 receives the registration result thereof from the process authentication and file I/O acquisition module 103 (step 1009), and when a registration success response is returned, the access to the confidential file 109 is allowed (step 1011). When a registration failure response is returned, the access to the confidential file 109 is prohibited (step 1012).

In FIG. 5, the process identifier registered in the process management table 107 is obtained from the OS, and the process name and the access authority therein are input from the cached application information 202 (the application name 301 is input as the process name 501). The date and time of process registration is registered by obtaining a current date and time from the clock of the client computer 1 by the process authentication and file I/O acquisition module 103. The accessible period and the access authority are extracted from the application authentication information 106 and transmitted to the process authentication and file I/O acquisition module 103 by the application authentication service 102.

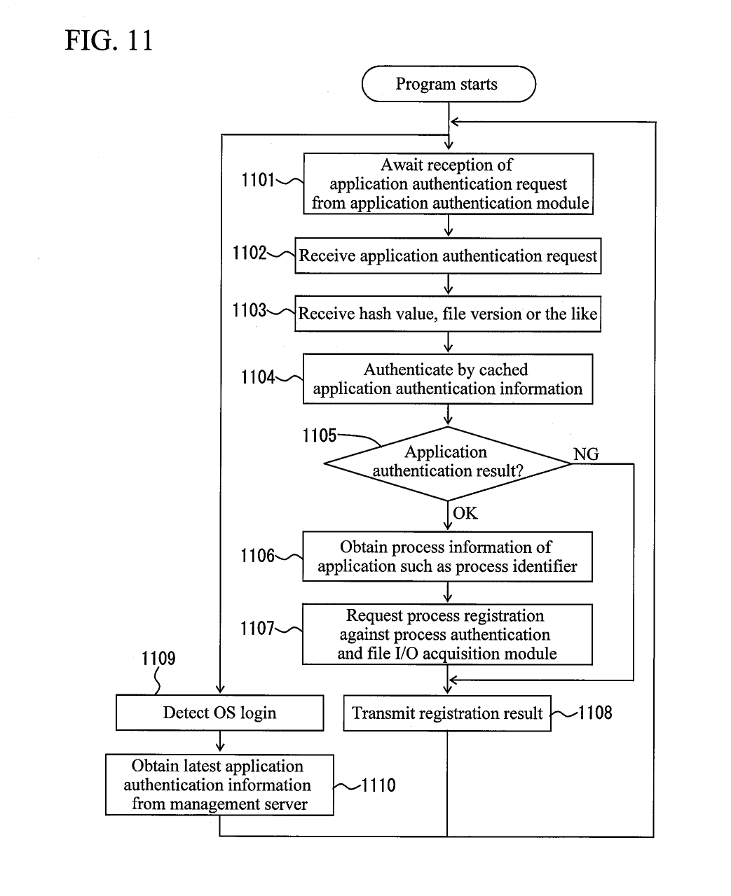

FIG. 11 is a flowchart for illustrating a process procedure in which the application authentication service 102 authenticates an application and the application authentication service 102 obtains the application authentication information 106 from the server computer 8.

When the application authentication service 102 is started, the application authentication service 102 awaits an application authentication request (step 1101). When the application authentication service 102 receives the application authentication request from the application authentication module 105 (steps 1102 and 1103), the application authentication service 102 searches the application information such as the hash value or the file version transmitted from the application authentication module 105 in the cached application authentication information 106, and judges whether the information has been already registered (step 1104). When the information has not been registered, an authentication failure result is returned to the request source. When the information has been already registered, the application authentication service 102 obtains the process information of the business application 101 from the OS and the application information 202 (step 1106), performs process registration in the process authentication and file I/O acquisition module 103 (step 1107) and returns a registration result to the request source (step 1108).

When the application authentication service 102 detects OS logon (step 1109), the application authentication service 102 obtains the latest application authentication information 106 from the management server (step 1110).

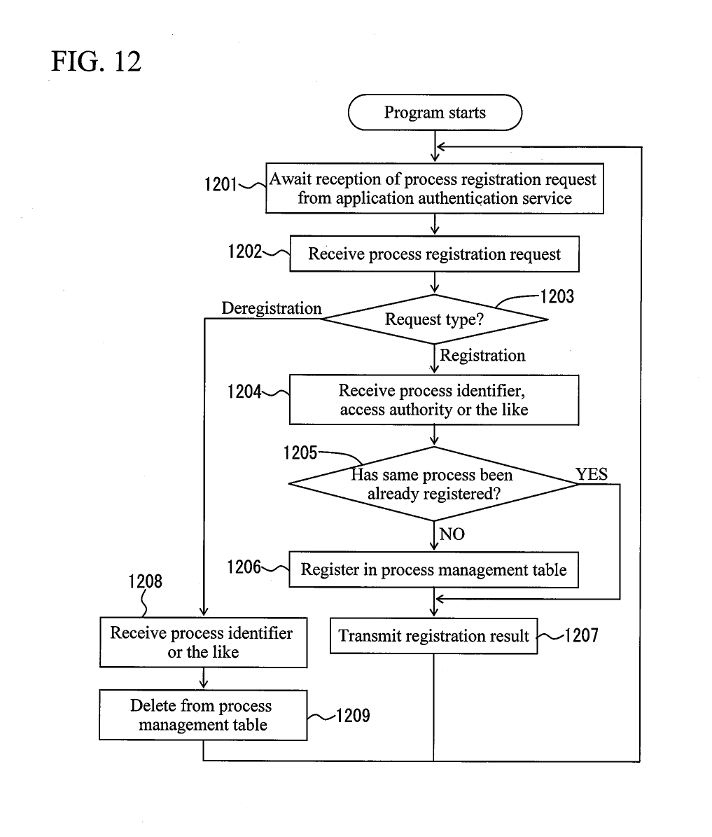

FIG. 12 is a flowchart for illustrating a process procedure in which the process authentication and file I/O acquisition module 103 registers a process.

When the process authentication and file I/O acquisition module 103 is started, the process authentication and file I/O acquisition module 103 awaits a process registration request from the application authentication service 102 (step 1201). When the process authentication and file I/O acquisition module 103 receives the process registration request (step 1202), the process authentication and file I/O acquisition module 103 confirms a request type (step 1203).

When the request type is “registration”, the process authentication and file I/O acquisition module 103 obtains the process information such as the process identifier from the OS and the application information 202 from the request source (step 1204), and confirms whether the same process has been already registered in the process management table 107 (step 1205). When the process has not been registered, the obtained process information is registered in the process management table 107 (step 1206). When the process has been already registered, the obtained process information is not registered. The process authentication and file I/O acquisition module 103 returns a success or failure response of the registration result to the request source (step 1207).

When the request type is “deregistration”, the process authentication and file I/O acquisition module 103 obtains the process information such as the process identifier from the request source (step 1208), and the obtained process identifier is deleted from the process management table 107 (step 1209).

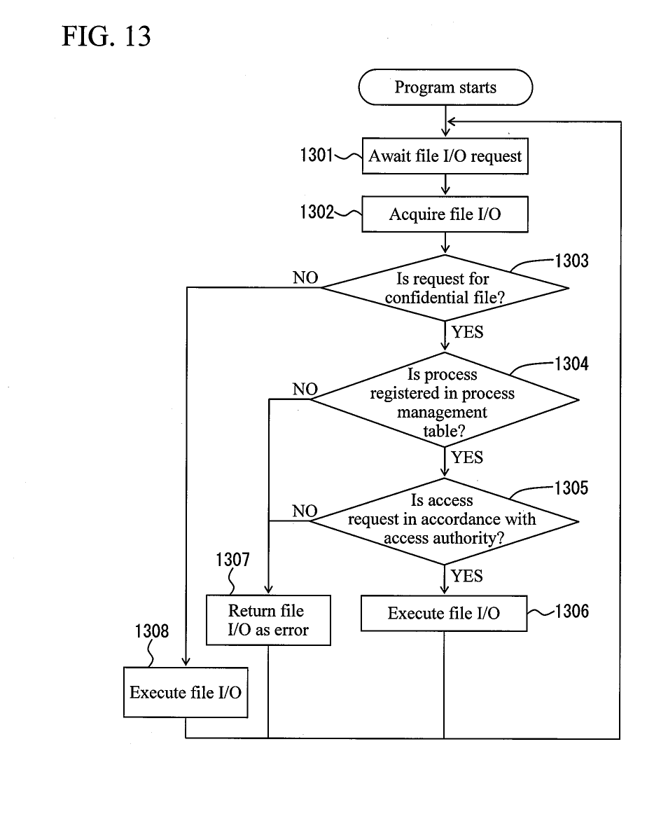

FIG. 13 is a flowchart for illustrating a procedure in which the process authentication and file I/O acquisition module 103 acquires access to the confidential file 109 and performs access control.

When the process authentication and file I/O acquisition module 103 is started, the process authentication and file I/O acquisition module 103 awaits a file I/O command as a file I/O acquisition function (step 1301). When the process authentication and file I/O acquisition module 103 acquires a file I/O command such as a file OPEN request (step 1302), the process authentication and file I/O acquisition module 103 confirms whether the I/O command is requested for the confidential file 109 (step 1303). When the I/O command is requested for the confidential file 109, the process authentication and file I/O acquisition module 103 further searches whether the process of an application that is the source of issuing the file I/O command is registered in the process management table 107 (step 1304). When the file I/O command is from the process of an authenticated application, the process authentication and file I/O acquisition module 103 performs access control in accordance with the access authority of the process information registered in the process management table 107 (step 1305).

For example, a business application which is authorized only to read the confidential file can only reference the confidential file 109. A business application which is authorized to write to the confidential file can edit the confidential file 109.

The process name and process identifier of the application that is the source of issuing the file I/O command are included in the file I/O command, and it is thereby judged whether the access is from the process registered in the process management table 107.

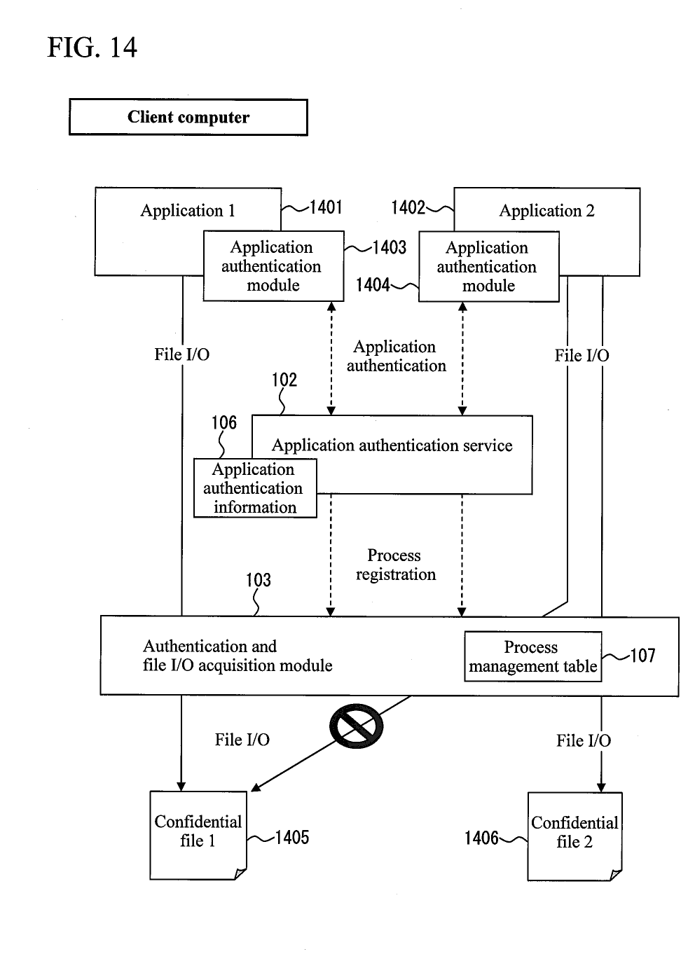

FIG. 14 shows another embodiment to which the present invention is applied.

In the embodiment, there are provided applications 1401 and 1402 which comprise application authentication modules 1403 and 1404 having the same function as that of the application authentication module 105 in FIG. 1.

Access to confidential files 1405 and 1406 is controlled by the process authentication and file I/O acquisition module 103 as files respectively storing confidential information.

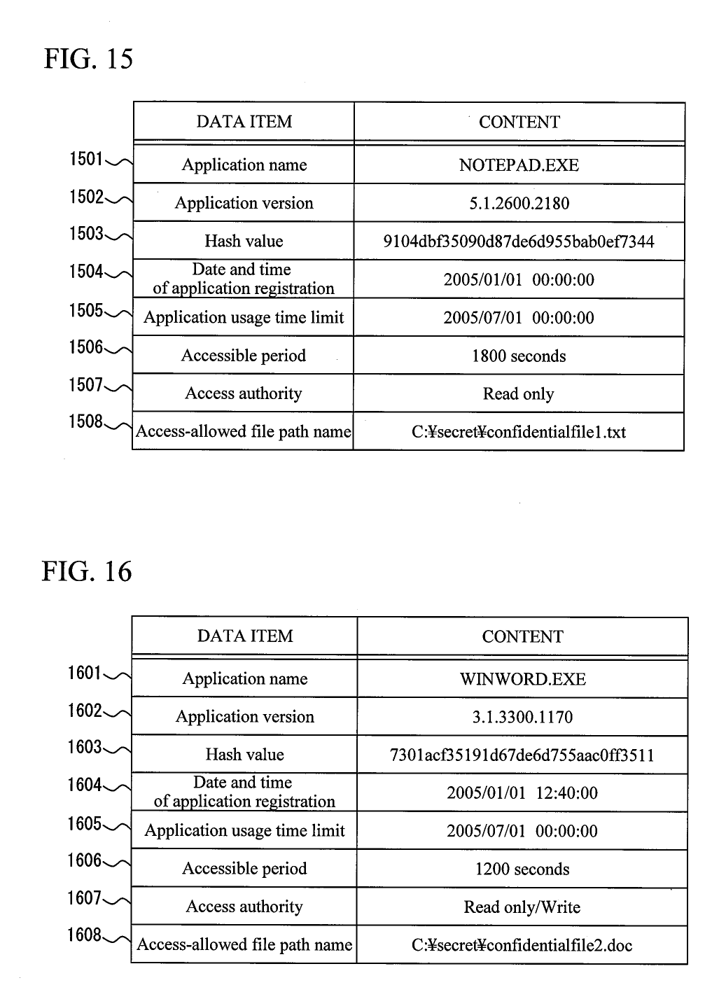

When the authentication information in FIG. 3 is extended so as to specify a file path name which is allowed to access the confidential file, application information in the application management table 108 with respect to the application 1401 is, for example, as shown in FIG. 15, and the application 1401 can issue an authentication request so as to access only the confidential file 1405 thereof (file path name “C:¥secret¥confidentialfile1.txt”).

Likewise, application information in the application management table 108 with respect to the application 1402 is, for example, as shown in FIG. 16, and the application 1402 can issue an authentication request so as to access only the confidential file 1406 thereof (file path name “C:¥secret¥confidentialfile2.doc”).

In the case of FIG. 14, when the application 1402 attempts to access the confidential file 1405 held by the application 1401, the application 1402 is judged to have no access authority in the step 1305 of the access control procedure since the confidential file 1405 file path name “C:¥secret¥confidentialfile1.txt” is not included in an access-allowed file path name 1608 of its application information (FIG. 16), and the application 1402 cannot access the confidential file 1405. Likewise, when the application 1401 attempts to access the confidential file 1406 held by the application 1402, the application 1401 is judged to have no access authority in the step 1305 of the access control procedure since the confidential file 1406 file path name “C:¥secret¥confidentialfile2.doc” is not included in an access-allowed file path name 1508 of its application information (FIG. 15), and the application 1401 cannot access the confidential file 1406. As described above, by separating accessible confidential files by each application, detailed access control can be achieved.

All publications, patents and patent applications cited in this specification are herein incorporated by reference.

Note that the present invention is not limited to the embodiments as described above, and reconfigurations, modifications or replacements may be made in a range without departing from the scope defined by the claims.

1. A method of protecting a confidential file to which unauthorized access is prohibited on business grounds, comprising:
a first step of registering a business application that is a source of an access request for the confidential file in an application management table held by an application management service operating in a server computer;
a second step of, at an application authentication service operating in a client computer, communicating with the application management service of the server computer and caching contents of the application management table in the client computer;
a third step of, at an application authentication module implemented in the business application, registering a process of the business application in a process management table of a process authentication and file I/O acquisition module operating in the client computer when the business application is the business application registered in application authentication information cached by the application authentication service; and
a fourth step of, at the process authentication and file I/O acquisition module, acquiring an access request for the confidential file, judging whether a process of a source of the access request is the process registered in the process management table, and prohibiting access to the confidential file when the process has not been registered, and allowing access to the confidential file when the process has been already registered.

2. The method of protecting a confidential file according to claim 1, wherein,
in the steps 1 and 3, information of an access authority and an accessible period to the confidential file is registered in the application management table and the process management table, and,
in the step 4, the access to the confidential file is limitedly allowed in accordance with the registered access authority and accessible period.

3. The method of protecting a confidential file according to claim 2, wherein,
in the steps 1 and 3, an access-allowed file path name is further registered in the application management table and the process management table, and,
in the step 4, the access to the confidential file is limitedly allowed in accordance with the registered access authority, accessible period, and access-allowed file path name.

4. A confidential file protecting system for protecting a confidential file to which unauthorized access is prohibited on business grounds, comprising:
first registering means for registering a business application that is a source of an access request for the confidential file in an application management table held by an application management service operating in a server computer;
caching means for, at an application authentication service operating in a client computer, communicating with the application management service of the server computer and caching contents of the application management table in the client computer;
second registering means for, at an application authentication module implemented in the business application, registering a process of the business application in a process management table of a process authentication and file I/O acquisition module operating in the client computer when the business application is the business application registered in application authentication information cached by the application authentication service; and
access allowing means for, at the process authentication and file I/O acquisition module, acquiring an access request for the confidential file, judging whether a process of a source of the access request is the process registered in the process management table, and prohibiting access to the confidential file when the process has not been registered, and allowing access to the confidential file when the process has been already registered.

5. The confidential file protecting system according to claim 4, wherein
the first registering means and the second registering means register information of an access authority and an accessible period to the confidential file respectively in the application management table and the process management table, and
the access allowing means limitedly allows the access to the confidential file in accordance with the registered access authority and accessible period.

6. The confidential file protecting system according to claim 5, wherein
the first registering means and the second registering means further register an access-allowed file path name respectively in the application management table and the process management table, and
the access allowing means limitedly allows the access to the confidential file in accordance with the registered access authority, accessible period, and access-allowed file path name.
